(19) United States
(12) Patent Application Publication
(10) Pub. No.: US 2021/0163510 A1
(43) Pub. Date: Jun. 3, 2021

(54) METHOD FOR PRODUCING CATIONIC SILICON(II) COMPOUNDS

(71) Applicant: WACKER CHEMIE AG, Munich (DE)

(72) Inventor: Elke FRITZ-LANGHALS, Ottobrunn (DE)

(73) Assignee: WACKER CHEMIE AG., Munich (DE)

(21) Appl. No.: 16/605,046

(22) PCT Filed: Apr. 13, 2017
(86) PCT No.: PCT/EP2017/058936

§ 371 Date: Oct. 14, 2019

(51) Int. Cl. C07F 7/08; C07F 5/02; B01J 31/14

(52) U.S. Cl. CPC C07F 7/0832; C07F 5/027; B01J 2231/323; B01J 2531/002; B01J 31/146

(57) ABSTRACT

Cationic silicon (ii) compounds are easily formed by reaction of π-bonded cyclopentadienyl silicon (II) compound with a carbo-cation. The compounds have catalytic uses, particularly as a hydrosilylation catalyst.

### CROSS REFERENCE TO RELATED APPLICATIONS

This application is the U.S. National Phase of PCT Appln. No. PCT/EP2017/058936 filed Apr. 13, 2017, the disclosure of which is incorporated in its entirety by reference herein.

### BACKGROUND OF THE INVENTION

### 1. Field of the Invention

The invention relates to a method for preparing cationic Si(II) compounds.

### 2. Description of the Related Art

Cationic silicon(II) compounds are highly reactive compounds which, on account of their electron structure, are of industrial interest in particular for catalytic purposes. The lack of synthetic accessibility in particular has so far obstructed use of this class of compounds. The compound (C₅Me₅) Si⁺B (C₆F₅)₄⁻ may, for example, be exclusively prepared from silicocene, (C₅Me₅)₂Si—as described in Chem. Eur. J. 2014, 20, 9192—by reaction of silicocene with the specific protic acid (C₅H₂Me₅)⁺B(C₆F₅)₄⁻, which is only accessible in a very complex, and at times safety-critical, 7-stage low-temperature synthesis as per Organometallics 2000, 19, 1442 in conjunction with Science, 2004, 305, 849. More easily accessible protic acids always lead, as stated in J. Organomet. Chem. 1993, 446, 139, to oxidative addition with formation of an adduct with tetravalent silicon.

There was therefore a need for a simpler method by which cationic silicon(II) compounds can be made accessible.

### SUMMARY OF THE INVENTION

The invention provides a method for preparing compounds having a cationic silicon(II) center of general formula I

([Si(II)Cp]⁺)ₐX^{a-} (I)

by reaction of the silicon(II) compounds of general formula II

[(HR^{b})Si(II)Cp] (II)

with a carbocationic compound of general formula (III)

(R^{c}^{₃}C⁺)ₐX^{a-} (III)

where
Cp denotes a π-bonded, formally negatively charged, unsubstituted or substituted cyclopentadienyl radical,
X^{a-} denotes an a-valent anion,
a denotes the values 1, 2 or 3,
HR^{b} denotes an R^{x}-radical-substituted, formally negatively charged cyclopentadienyl radical of general formula V

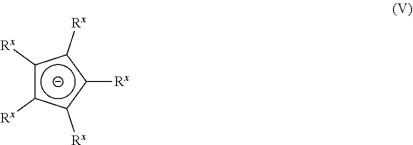

R^{x} independently of one another denote hydrogen, linear or branched, acyclic or cyclic, saturated or mono- or polyunsaturated C1-C20-alkyl or C6-C20-aryl radicals, with the proviso that at least one of the radicals R^{x} denotes a group CHR¹R²,
R¹ and R² independently of one another denote hydrogen, linear or branched, acyclic or cyclic, saturated or mono- or polyunsaturated C1-C20-alkyl or C6-C20-aryl radicals and
R^{c} denote monovalent aromatic radicals which may be unsubstituted or substituted by halogen atoms or monovalent or polyvalent organic radicals, which may also be joined to one another to form fused rings.

### DETAILED DESCRIPTION OF THE PREFERRED EMBODIMENTS

The invention is thus directed to a method for preparing compounds having a cationic silicon(II) center of general formula I

([Si(II)Cp]⁺)ₐX^{a-} (I)

by reaction of the silicon(II) compounds of general formula II

[(HR^{b})Si(II)Cp] (II)

with a carbocationic compound of general formula (III)

(R^{c}₃C⁺)ₐX^{a-} (III)

where
Cp denotes a π-bonded, formally negatively charged, unsubstituted or substituted cyclopentadienyl radical,
X^{a-} denotes an a-valent anion,
a denotes the values 1, 2 or 3,
HR^{b} denotes an R^{x}-radical-substituted, formally negatively charged cyclopentadienyl radical of general formula V

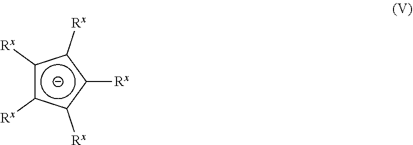

R^{x} independently of one another denote hydrogen, linear or branched, acyclic or cyclic, saturated or mono- or polyunsaturated C1-C20-alkyl or C6-C20-aryl radicals, with the proviso that at least one of the radicals R^{x} denotes a group CHR¹R²,
R¹ and R² independently of one another denote hydrogen, linear or branched, acyclic or cyclic, saturated or mono- or polyunsaturated C1-C20-alkyl or C6-C20-aryl radicals and
R^{c} denote monovalent aromatic radicals which may be unsubstituted or substituted by halogen atoms or monovalent or polyvalent organic radicals, which may also be joined to one another to form fused rings.

It has surprisingly been found that cationic silicon(II) compounds can be prepared by transferring a negatively charged hydrogen atom, a hydride ion, to a carbocationic compound of general formula III. In this reaction, a negatively charged hydrogen atom, a hydride ion, is selectively transferred from a group CHR¹R² of the radicals R^{x}, which is present in HR^{b}, to the carbocation R^{c}₃C⁺, wherein a compound R^{c}₃C—H forms in addition to the desired cationic Si(II) compound [Si(II)Cp]⁺. The counteranion X^{a-} of the carbocation R^{c}₃C⁺ after the reaction forms the counteranion of the cationic silicon(II) compound of general formula I.

Carbocations of general formula III are very readily accessible synthetically. In this way, the accessibility of the cationic silicon(II) compounds is thus substantially simplified. A further advantage is that the reaction is effected with high yield.

The reaction proceeding in the method will be explained by way of example using a preferred cyclopentadienyl radical HR^{b} defined as Cp-CHR¹R² in the compound having general formula II and using a preferred carbocation, specifically the tritylium cation Ph₃C⁺, in the compound of general formula III. In the method, a hydride ion is transferred to Ph₃C⁺ to form triphenylmethane, Ph₃C—H, and the compound Cp=CR¹R² (corresponding to R^{b}) as per reaction equation 1,

[(Cp-CHR¹R²)Si(II)Cp]+Ph₃C⁺X⁻=>Cp=CR¹R²+(Si(II)Cp)⁺+HCPh₃+X⁻ (1)

By cleaving a hydride ion from HR^{b}, the silicon center gains a positive charge.

The compound X⁻ forms the counterion to the cationic silicon(II) compound (CpSi)⁺.

The Cp radical in the compound having general formula I preferably has general formula IV

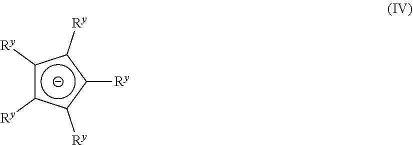

The radicals R^{y}, preferably independently of one another, preferably denote hydrogen, linear or branched, acyclic or cyclic, saturated or mono- or polyunsaturated C1-C20-alkyl or C6-C20-aryl, more preferably C1-C3-alkyl, and most preferably, methyl radicals.

Examples of radicals R^{y} are alkyl radicals such as the methyl, ethyl, n-propyl, isopropyl, n-butyl, sec-butyl, isobutyl, tert-butyl, n-pentyl, sec-pentyl, isopentyl, neopentyl, and tert-pentyl radicals; hexyl radicals such as the n-hexyl radical; heptyl radicals such as the n-heptyl radical; octyl radicals such as the n-octyl radical and isooctyl radicals such as the 2,4,4-trimethylpentyl radical; nonyl radicals, such as the n-nonyl radical; decyl radicals such as the n-decyl radical; dodecyl radicals such as the n-dodecyl radical; hexadecyl radicals such as the n-hexadecyl radical; octadecyl radicals, such as the n-octadecyl radical; cycloalkyl radicals such as the cyclopentyl, cyclohexyl, cycloheptyl radical and methylcyclohexyl radical; aryl radicals such as the phenyl, naphthyl, anthryl and phenanthryl radicals; alkaryl radicals such as the o-, m- and p-tolyl, xylyl, mesitylenyl, and o-, m- and p-ethylphenyl radicals; and aralkyl radicals such as the benzyl radical and the α- and the β-phenylethyl radicals.

X^{a-} denotes an a-valent anion which can be either inorganic or organic. The valence a preferably has a value of 1 or 2, especially 1.

X^{a-} is preferably [ClO₄]⁻, [OTf]⁻, [FSO₃]⁻ or a preferably inorganic, preferably complex anion selected from halides of the elements boron, aluminum, gallium, germanium, tin, phosphorus, arsenic and antimony, wherein an individual or a plurality of halogen substituents may be replaced with carbon-containing radicals, preferably C1-C20 unsubstituted or halogen-atom-substituted hydrocarbon or hydrocarbonoxy radicals, especially alkyl, aryl or alkoxy radicals, where fluorinated or chlorinated hydrocarbon radicals are particularly preferred, or preferably a carborate anion.

As known to the skilled person, such preferred anions X^{a-} are referred to as weakly coordinating anions (WCA), because they have a low affinity for reactive cationic structures. An overview of this topic is given by the article by I. Krossing et al., in Chem. Soc. Rev. 2016, 45, 789-899.

The following anions are very particularly preferred as X^{a-}: [ClO₄]⁻, [OSO₂CF₃]⁻, [FSO₃]⁻, [BF₄]⁻, [B (CF₃)₄]⁻, [BFh₄]⁻, [B (Ar^{CF3})₄]⁻, [B (Ar^{Cl}) ₄]⁻, [HB (C₆F₅)₃]⁻, [B (C₆F₅)₄]⁻, [MeB(C₆F₅)₃]⁻, [MeB (C₁₂F₉)₃]⁻, [AlCl₄]⁻, [AlBr₄]⁻, [AlI₄]⁻, [Al(OR^{PF})₄]⁻, [Al (OR^{HF})₄]⁻, [Al(OP^{MF})₄]⁻, [Cl{Al(OR^{PF})₃}₂]⁻, [ClAl(OR^{PF})₃]⁻, [(R^{PF}O)₃Al—F—Al(OR^{PF})₃]⁻, [FAl{C₆F₁₀(C₆F₅)}₃]⁻, [Al₂Br₇]⁻, [GaCl₄]⁻, [Ga₂Cl₇]⁻, [Cl₂Ga(FP)₂]⁻, [Ga(C₆F₅)₄]⁻, [GeBr₃]⁻, [GeCl₃]⁻, [GeF₆]²⁻, [SnCl₃]⁻, [SnBr₃]⁻, [SnCl₆]²⁻, [PF₆]⁻, [AsF₆]⁻, [AS₂F₁₁]⁻, [SbF₆]⁻, [Sb₂Cl₈]²⁻, [Sb₂F₁₁]⁻, [Sb₃F₁₆]⁻, [Sb₄F₂₁]⁻, where Ar^{CF3} denotes 3,5-(CF₃)₂C₆H₃, Ar^{Cl} denotes pentachlorophenyl, OR^{MF} denotes —OC(CH₃) (CF₃)₂, OR^{PF} denotes —OC(CF₃)₃ and OR^{HF} denotes —OC(H) (CF₃)₂,

[CB₁₁H₁₂]⁻, [CHB₁₁H₅Cl₆]⁻, [CHB₁₁H₅Br₆]⁻, [CHB₁₁F₁₁]⁻, [C (Et) B₁₁F₁₁]⁻, [CB₁₁(CF₃)₁₂]⁻, [HCB₁₁Cl₁₁]⁻, [HCB₁₁I₁₁]⁻, [HCB₉H₄Br₅]⁻, [HCB₁₁H₅Br₆]⁻, [HCB₁₁H₅Cl₆]⁻, [CB₁₁Me₅Br6]⁻, [HCB₁₁Me₅Cl₆]⁻, [CB₁₁H₆X₆]⁻ where X═Cl, Br or [B₁₂Cl₁₂]²⁻.

Examples of radicals R^{x} are alkyl radicals such as the methyl, ethyl, n-propyl, isopropyl, n-butyl, sec-butyl, isobutyl, tert-butyl, n-pentyl, sec-pentyl, isopentyl, neopentyl, and tert-pentyl radicals; hexyl radicals such as the n-hexyl radical; heptyl radicals such as the n-heptyl radical; octyl radicals such as the n-octyl radical, and isooctyl radicals such as the 2,4,4-trimethylpentyl radical; nonyl radicals, such as the n-nonyl radical; decyl radicals such as the n-decyl radical; dodecyl radicals such as the n-dodecyl radical; hexadecyl radicals such as the n-hexadecyl radical; octadecyl radicals such as the n-octadecyl radical; cycloalkyl radicals such as the cyclopentyl, cyclohexyl, cycloheptyl radical and methylcyclohexyl radicals; aryl radicals such as the phenyl, naphthyl, anthryl and phenanthryl radical; alkaryl radicals such as the o-, m- and p-tolyl, xylyl, mesitylenyl and o-, m- and p-ethylphenyl radical; and aralkyl radicals such as the benzyl radical and the α- and the β-phenylethyl radicals.

The radicals R^{x} in the compound of general formula V independently of one another preferably denote hydrogen, more preferably C1-C3-alkyl radicals, and most preferably methyl radicals.

The radicals R¹ and R² independently of one another preferably denote hydrogen, more preferably C1-C3-alkyl radicals, and most preferably methyl radicals.

Preferred radicals R^{c} are unsubstituted or halogen-atom-substituted phenyl, tolyl, xylyl, mesitylenyl and ethylphenyl radicals.

Especially preferred radicals R^{c} are phenyl, pentafluorophenyl, pentachlorophenyl, o-, m- and p-tolyl, xylyl, mesitylenyl and o-, m- and p-ethylphenyl radicals.

Preferred examples of compounds having general formula I are Ph₃C⁺B(C₆F₅)₄⁻, Ph₃C⁺BF₄⁻, Ph₃C⁺PF₆⁻, Ph₃C⁻P[HCB₁₁Cl₁₁]⁻ and Ph₃C⁺ClO₄⁻.

During the reaction as per reaction equation 1, the compound HCPh₃ forms, and additionally the cleavage product R^{b}, which as per exemplary reaction equation 1 has the meaning Cp=CR¹R². Cleavage products R^{b} can be left in the reaction mixture or else be separated off, when this is advantageous, for example if R^{b} interferes with the use of compound I.

The separation can be effected in a manner known to the skilled person, for example by distillation or by fractional crystallization. In the distillation method, the compound R^{b} is distilled off, preferably under reduced pressure. If the separation is effected by crystallization, the compound of general formula I is preferably crystallized out by addition of a precipitant; the compound of general formula R^{b} remains in solution and can by way of example be removed by filtration.

The molar ratio of the compound of general formula II to the carbocationic compound of general formula III is preferably at least 1:10 and at most 10:1, more preferably at least 1:5 and at most 5:1, and most preferably at least 1:3 and at most 3:1. The two components can be mixed in any desired order here, the mixing being effected in a manner known to the skilled person. The compound of general formula II is preferably admixed with the carbocationic compound of general formula III.

The reaction in accordance with the invention may be conducted in the presence of one or more further components, by way of example in the presence of a solvent or a mixture of a plurality of solvents.

Either the compound of general formula II or the compound III, or both components, can be dissolved in a solvent or in a mixture of solvents. The proportion of the solvent or mixture of solvents, based on the sum total of compounds of general formulae II and III, is preferably at least 0.1 wt. % and not more than a 1000-fold amount by weight, more preferably at least 10 wt. % and not more than a 100-fold amount by weight, and most preferably at least 30 wt. % and not more than a 10-fold amount by weight.

Examples of solvents that may be used include hydrocarbons such as pentane, hexane, heptane, cyclohexane or toluene, chlorohydrocarbons such as dichloromethane, chloroform, chlorobenzene or 1,2-dichloroethane, ethers such as diethyl ether, methyl Cert-butyl ether, anisole, tetrahydrofuran or dioxane, or nitriles such as, for example, acetonitrile or propionitrile.

The reaction in accordance with the invention to form the compound having general formula I can also be effected in the presence of components that react in the presence of the compound of general formula I. The compound of general formula I acting as catalyst for the reaction of the further components is in this case generated in the presence of the reactants.

The reaction can be conducted at ambient pressure or at reduced or elevated pressure.

The pressure is preferably at least 0.01 bar and at most 100 bar, more preferably at least 0.1 bar and at most 10 bar, and the reaction is most preferably conducted at ambient pressure.

The reaction in accordance with the invention is preferably effected preferably at temperatures between at least −100° C. and at most +250° C., more preferably between at least −20° C. and at most +150° C., and most preferably between at least 0° C. and at most +100° C.

The cationic silicon(II) compound of general formula I can be used as a catalyst, for example for hydrosilylations. As shown using the example of hydrosilylation, processes that are catalyzed by silicon(II) compounds of general formula I proceed particularly uniformly and without appreciable formation of by-products.

All of the above symbols of the above formulae are each defined independently of one another. The silicon atom is tetravalent in all formulae except in the silicon (II) compounds herein.

Unless indicated otherwise, all amounts and percentages are based on weight, and all temperatures are 20° C.

### EXAMPLE

All work steps are conducted under Ar. 102 mg (0.342 mmol) of silicocene (Cp*₂Si, Cp*=pentamethylcyclopentadienyl) are dissolved in 3.5 ml of dichloromethane and admixed at room temperature with 310 mg (0.336 mmol) of trityl tetrakis(pentafluorophenyl)borate (Ph₃C⁺B(C₆F₅)₄⁻) in 3.5 ml of dichloromethane while shaking. The homogeneous solution is admixed dropwise with n-decane until a solid precipitates. The supernatant solution is decanted off and the solid washed three times with 1 ml of n-hexane each time and dried under reduced pressure. The solid consists of Cp*Si⁺B(C₆F₅)₄⁻.

¹H NMR (CD₂Cl₂) : δ=2.24 (s, CH₃ of Cp) , ¹⁹F NMR: δ=−167.5 (m, 2 F), −163.6 (m, 1F), −133.0 (m, 2F).

The compound is stable at ambient temperature (25° C.) over a period of at least 3 months.

1.-7. (canceled)

8. A method for preparing compounds comprising a cationic silicon(II) center of Formula I
([Si(II)Cp]⁺)ₐX^{a-} (I)
comprising reacting one or more silicon(II) compounds of Formula II
[(HR^{b})Si(II)Cp] (II)
with a carbocationic compound of Formula (III)
(R^{c}₃C⁺)ₐX^{a-} (III)
where
Cp denotes a π-bonded, formally negatively charged, unsubstituted or substituted cyclopentadienyl radical, of Formula IV 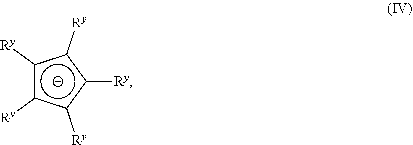
where
R^{y} independently of one another denote hydrogen, linear or branched, acyclic or cyclic, saturated or mono- or polyunsaturated. C1-C20-alkyl or C6-C20-aryl radicals,
X^{a-} denotes an a-valent anion,
a denotes the values 1, 2 or 3,
HR^{b} denotes an R^{x}-radical-substituted, formally negatively charged cyclopentadienyl radical of formula V 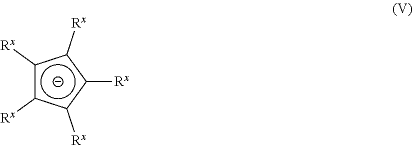
R^{x} independently of one another denote hydrogen, linear or branched, acyclic or cyclic, saturated or mono- or polyunsaturated C1-C20-alkyl or C6-C20-aryl radicals, with the proviso that at least one of the radicals R^{x} denotes a group CHR¹R²,
R¹ and R² independently of one another denote hydrogen, linear or branched, acyclic or cyclic, saturated or mono- or polyunsaturated C1-C20-alkyl or C6-C20-aryl radicals and
R^{c} denote monovalent aromatic radicals which may be unsubstituted or substituted by halogen. atoms or monovalent or polyvalent organic radicals, which may also be joined to one another to form fused rings.

9. The method of claim 8, wherein X^{a-} is selected from the group consisting of [ClO₄]⁻, [OTf]⁻, [FSO₃]⁻ and anions which are halides of the elements boron, aluminum, gallium, germanium, tin, phosphorus, arsenic and antimony, wherein individual or a plurality of halogen substituents of the halides are optionally replaced with carbon-containing radicals, a carborate anion, and mixtures thereof.

10. The method of claim 8, wherein R¹ and R² independently of one another denote hydrogen or C1-C3-alkyl radicals.

11. The method of claim 9, wherein R¹ and R² independently of one another denote hydrogen or C1-C3-alkyl radicals.

12. The method of claim 8, wherein the radicals R^{c} are selected from the group consisting of unsubstituted or halogen-atom-substituted phenyl radicals, tolyl. radicals, xylyl radicals, mesitylenyl radicals, ethylphenyl radicals, and mixtures thereof.

13. The method of claim 9, wherein the radicals R^{c} are selected from the group consisting of unsubstituted or halogen-atom-substituted phenyl radicals, tolyl radicals, xylyl radicals, mesitylenyl radicals, ethylphenyl radicals, and mixtures thereof.

14. The method of claim 10, wherein the radicals R^{c} are selected from the group consisting of unsubstituted or halogen-atom-substituted phenyl. radicals, tolyl radicals, xylyl radicals, inesitylenyl radicals, ethyiphenyl radicals, and mixtures thereof.

15. The method of claim 11, wherein the radicals R^{c} are selected from the group consisting of unsubstituted or halogen-atom-substituted phenyl radicals, tolyl radicals, xylyl radicals, mesitylenyl radicals, ethylphenyl radicals, and mixtures thereof.

16. The method of claim 8, wherein R^{x} are C1-C3-alkyl radicals.

17. The method of claim 9, wherein R^{x} are C1-C3-alkyl radicals.

18. The method of claim 11, wherein R^{x} are C1-C3-alkyl radicals.

19. The method of claim 8, wherein the method which is conducted in an aprotic solvent selected from the group consisting of hydrocarbons, chlorohydrocarbons, ethers, nitriles, organosilanes, organosiloxanes, and mixtures thereof.
